(19) United States
(12) Patent Application Publication
(10) Pub. No.: US 2003/0086617 A1
(43) Pub. Date: May 8, 2003

(54) Triangle automatic matching method

(76) Inventor: Jer-Chuan Huang, Hsin Chuan City (TW)

Correspondence Address: Keith Kline, PRO-TECHTOR INTERNATIONAL SERVICES, 20775 Norada Court, Saratoga, CA, 95070-3018, US

(21) Appl. No.: 10/040,114

(22) Filed: Oct. 25, 2001

(51) Int. Cl. G06K 9/68

(52) U.S. Cl. 382/218

(57) ABSTRACT

The invention discloses a triangle automatic matching method to provide a unique and precise matching method that can be used to judge the similarity of two sets of planar points. The methods comprise of steps: (a) Generate the triangular elements and matching-related flag matrices. (b) Determine the triangle weighting value combined with triangle coarse matching. (c) Convert the coordinate. And (d) calculate the similarity.

### BACKGROUND OF INVENTION

1. Field of the Invention

The invention relates to a precise and automatic matching method for two sets of planar point patterns, especially to the auto matching method and the application thereof such as biometric system.

2. Description of the Related Art

Methods for identifying two or more sets of planar points pattern become a more popular topic in science and technology. The primary goal of these methods using digital system is to distinguish whether two or more planar point patterns are similar or not. The fields of applications directly related to these methods include computer vision and image processing. An example of these applications is recognition of hand-written characters such as OCR (Optical character recognition), and another good example is the biometrics, which use the physical or behavioral characters of human to achieve personal ID identify. Since the advent of Internet, through Internet, fingerprints and iris identification methods, have been provided to support electrical commerce, information security, on-line order and payment, or credit card service. In addition, these technologies also support off-line system, security control of automobile lock, and the launching for engine system. The prior art matching methods for the planar points, such as Fuzzy relaxation, and point-to-line voting, for example, U.S. Pat. Nos. 5,392,367, 5,974,176, and 5,991,430, are conducted in six matching procedures. The first is to abstract the input parameters of all the points. The second is to precede the coarse-matching to filter out the impossible matched pairs by means of the distance and angle between points. The third is to use either Fuzzy relaxation or point-to-line voting method to find out the four most possible matched pairs. The fourth is to determine the rotation and translation of these two sets of planar points from four most possible matched pairs mentioned by the third procedure. The fifth is to convert the coordinates and to find the summation of distance. And the sixth is to use the summation of distance from the fifth procedure to calculate the similarity. However, neither Fuzzy relaxation method nor Point-to-line method can determine the four most matched pairs rigid enough. Once the first of the four matched pairs are selected mistakenly, these methods will give a totally unexpected result due to incorrect rotation and translation. According to the drawback of the prior art, the invention further provides a method, triangle-matching method, which can overcome the drawback of the prior art described.

### SUMMARY OF THE INVENTION

The invention refers to the Huber Space Telescope matching method, using the triangular elements to determine the translation and rotation of the coordinates between the images of starts and the database. But the invention further improves the Huber Space Telescope method because of only by the side of a triangle, not by the entire triangle like the Huber Space Telescope method, to determine the geometrical information. The invention comprises of the following steps:

(a) Generate the triangular element matrices; generate a list of all the possible sides of a triangle basing on the vertices of the others triangle and 12 geometrical parameters stored in two matrices such as T_{I} and T_{R}, wherein the subscripts I and R individually represent the input and reference. According to the 12 geometrical parameters stored in these matrices, one can confirm the first four matched pairs. As a result, this step can considerably reduce the possibility of wrong selection.

(b) Generate matching-related flag matrix such as FM; the two point patterns sets p and q can be related to each other under the following conditions,

|xₚ−x_{q}|<X&|yₚ−y_{q}|<Y&|θₚ−θ_{q}|<Θ,

, wherein subscripts p and q represent the coordinate and the characteristic angle θ in the input test set P and the reference set Q. Further X, Y are the tolerances of the differences of the position. Θ is the tolerance of the difference of characteristic angle between these two sets. If all the conditions are satisfied, then set flag fm[pq]=1. wherein fm[pq] is the element of the Martix FM

(c) Determine the triangle weighting value in combination with the triangle coarse matching thereof; Triangle weighting value has two benefits: one is to find the tendency of direction about the triangular elements, the other is to determine the shift and rotation parameters. Before this procedure, there is an apriority value, fm[pq], needs to be verified. If fm[pq]=1, then go on with triangle coarse matching. Triangle coarse matching, in which the propose is to filter out the impossible mated points of triangle elements according to their geometrical parameter in the input set P and reference set Q. Set the several conditions to determine whether a triangle element from pattern P and a triangle element from pattern Q are definitely mated or not:

|T_{I}(l₁)−T_{R}(l₁)|<L&|T_{I}(l₂)−T_{R}(l₂)|<L&|T_{I}(l₃)−T_{R}(l₁)|<L;

|T_{I}(λ₁)−T_{R}(λ₁)|<Λ&|T_{I}(λ₂)−T_{R}(λ₂)|<Λ&|T_{I}(λ₃)−T_{R}(λ₃)|<Λ;

|T_{I}(θ₁)−T_{R}(θ₁)|<Θ&|T_{I}(θ₂)−T_{R}(θ₂)|<Θ&|T_{I}(θ₃)−T_{R}(θ₃)|<Θ;

|T_{I}(α₁)−T_{R}(α₁)|<A&|T_{I}(α₂)−T_{R}(α₂)|<A&|T_{I}(α₃)−T_{R}(α₃)|<A,

wherein the subscripts 1, 2, 3 represent the vertices of a triangle and L, Λ, Θ and A are the thresholds.

If the geometric parameters do not satisfy any of the conditions, then we can discard those elements that are impossible mated and the information about those elements will not go to determine the triangle weighting value. However, once a pair of triangles meets all the conditions, then the direction of a triangle element, such as D, can be defined as the average of the difference between input I and reference R angles:

$$D = \frac{\vert {T}_{I} ( {α}_{1} ) - {T}_{R} ( {α}_{1} ) \vert + \vert {T}_{I} ( {α}_{2} ) - {T}_{R} ( {α}_{2} ) \vert + \vert {T}_{I} ( {α}_{3} ) - {T}_{R} ( {α}_{3} ) \vert}{3} ,$$

where the angles αᵢ are between each side of a triangle and the X-axis.

The weight of all the possible matched pairs of triangle elements is:

$$W ( {D}_{m} ) = {\sum }_{i = 1}^{{N}_{p}} {\sum }_{j = 1}^{{N}_{p}} {\sum }_{k = 1}^{{N}_{p}} {\sum }_{r = 1}^{{N}_{q}} {\sum }_{g = 1}^{{N}_{q}} {\sum }_{t = 1}^{{N}_{q}} [ L - ( \vert {T}_{I} ( {l}_{ij} ) - {T}_{R} ( {l}_{rs} ) \vert ) + L - ( \vert {T}_{I} ( {l}_{ik} ) - {T}_{R} ( {l}_{rt} ) \vert ) + L - ( \vert {T}_{I} ( {l}_{jk} ) - {T}_{R} ( {l}_{st} ) \vert ) ] ,$$

where T_{I} and T_{R} are the matched number of points in the input set and the reference set respectively, and L is the threshold of length.

(d) Convert the coordinate; to convert a set of the points to the new coordinate needs to determine four parameters, which can be derived from the four most matched pairs in the highest weighting value direction Dₕ, i.e. for every m, W(Dₕ)=max{W(Dₘ)} (m=1, 2, . . . n), Where the angle depending on the weighting value thereof is introduced in the step(c). Use the four most matched pairs to determine the rotation and translation parameters of coordinate, in which convert the set of the points to the new coordinate:

$$[ \begin{matrix}NewX \\ NewY\end{matrix} ] = [ \begin{matrix}{t}_{1} \\ {t}_{2}\end{matrix} ] + [ \begin{matrix}{r}_{1} & - {r}_{2} \\ {r}_{2} & {r}_{2}\end{matrix} ] [ \begin{matrix}X \\ Y\end{matrix} ] ,$$

where t₁ and t₂ are the translation parameters, r₁ and r₂ are the rotation parameters. After finding these four parameters, the coordinate can be converted into the new one.

(e) Calculate the similarity; the similarity is determined by the combinations of the weighting value such as W and the number of matching points such as N, the average of the distance between each correctional new points of one set and corresponding points of another set. The similarity, such as (Sim), is simply a algebra function of weighting value such as (W). Inverse of the average distance

$$( \frac{1}{S} ) ,$$

number of matching pairs (Nₘ),the number of points in input set (Nₚ)and the number of points in reference set (N_{q}). Therefore, it is defined as,

$$Sim = \frac{{WN}_{m}^{2}}{{SN}_{p} {N}_{q}} ,$$

which can be completed the triangle matching method of the invention.

### BRIEF DESCRIPTION OF THE DRAWINGS

The following detailed description, given by way of examples and not intended to limit the invention to the embodiment described herein, will best be understood in conjunction with the accompanying drawings, in which:

FIG. 1 illustrates the flow chart diagram of the invention;

FIG. 2 illustrates the details of the flow chart of FIG. 1;

FIG. 3 illustrates a schematic diagram for the specific 12 geometrical parameters of the invention;

FIG. 4 illustrates a schematic diagram of the characteristic angle D_{c}, using symbol θ presents in this figure;

FIG. 5 a-d illustrates tables of the points and their feature direction in X-Y coordinates of two pair of patterns, where one pair of patterns is similar and another is not;

FIG. 6a-d illustrates tables or diagrams of the position of two pairs of set in two dimension space, where one pair of points is similar and another is not;

FIGS. 7a-h illustrates the tables or diagrams of results of the two pair of planar points patterns after triangle coarse matching;

FIGS. 8a-d illustrates tables or diagrams of the results after converting coordinate process alter;

FIGS. 9a-d illustrates the diagrams of the positions of similar or non-similar test pattern; and

FIG. 10 illustrates a diagram of FAR/FRR.

### DETAIL DESCRIPTION OF THE INVENTION

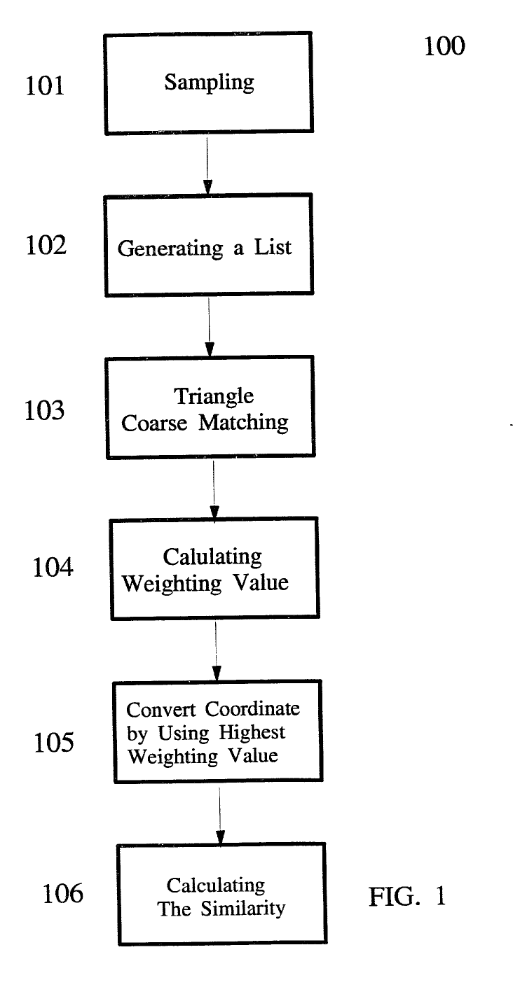

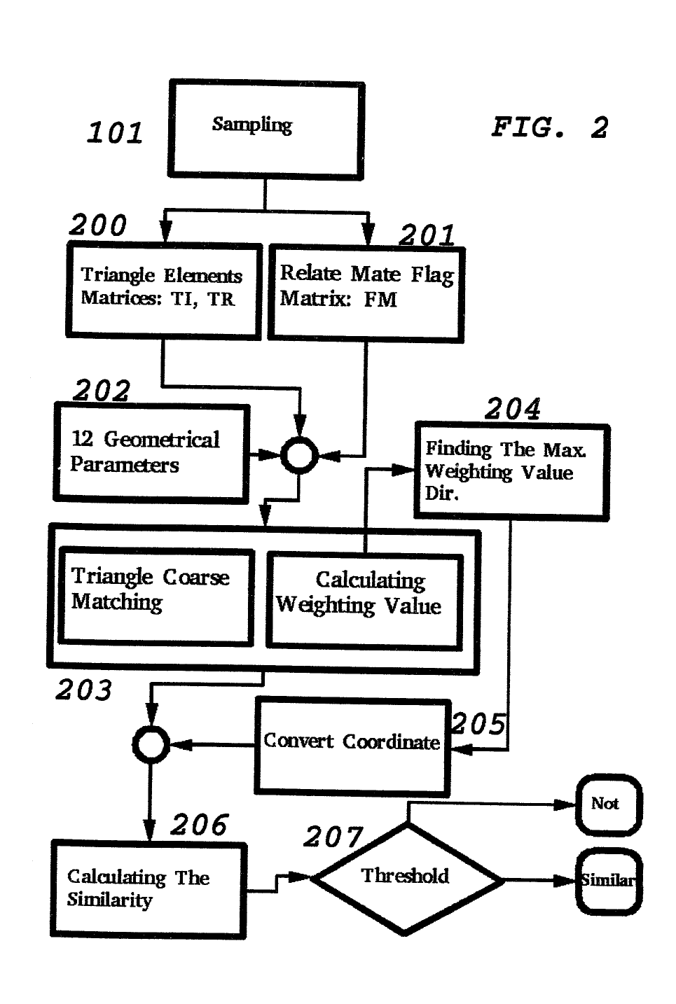

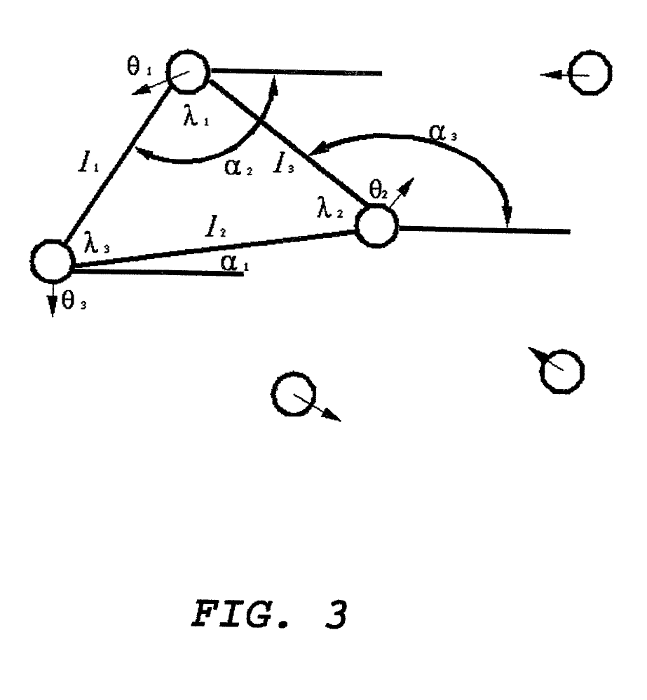

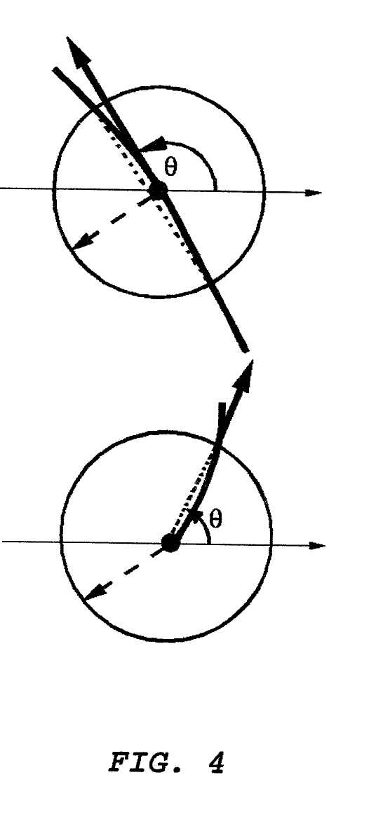

Referring to FIG. 1, which illustrates the flow chart 100 of the invention; in the step 101 and 102, generate a list of all the possible sides of a triangle based on the vertices of each triangle and store all the 12 geometrical parameters in the two matrices such as T_{I} and T_{R}, wherein the subscript I and R individually represent the input and reference. According to the 12 geometrical parameters stored in these matrices, which one can confirm the first four matched pairs, as a result, which can considerably reduce the possibility of wrong selection. In addition, by generating matching-related flag matrix such as Fm, the two point patterns sets p and q can be related to each other under the following conditions, as shown in FIG. 3,

|xₚ−x_{q}|<X&|yₚ−y_{q}|<Y&|θₚ−θ_{q}|<θ, (1)

wherein subscripts p and q represent the coordinate and the characteristic angle, as shown in FIG. 4 which illustrates the characteristic angle, using symbol θ to represent in this figure, in the input test set P and the reference set Q. further X, Y are the tolerances of the differences of the position while Θ is the tolerance of the differences of characteristic angle between these two sets. If all the conditions are satisfied, then set flag fm[pq]=1. In the step 103 and 104, determine the triangle weighting value combined with triangle coarse matching; Before processing this procedure, there is an apriority value needs to be verified. If fm[pq]=1, then go on with triangle coarse matching. i.e. :

∀fm[pq],p∈P,q∈Q:fm[pq]=1. (2)

Triangle coarse matching, in which the propose is to filter out the impossible mated points of triangle elements according to their geometrical parameter in the input set P and reference set Q. Set the several conditions to determine whether a triangle element from pattern P and a triangle element from pattern Q are definitely mated or not:

|T_{I}(l₁)−T_{R}(l₁)|<L&|T_{I}(l₂)−T_{R}(l₂)|<L&|T_{I}(l₃)−T_{R}(l₁)|<L|T_{I}(λ₁)−T_{R}(λ₁)|<Λ&|T_{I}(λ₂)−T_{R}(λ₂)|<Λ&|T_{I}(λ₃)−T_{R}(λ₃)|<Λ|T_{I}(θ₁)−T_{R}(θ₁)|<Θ&|T_{I}(θ₂)−T_{R}(θ₂)|<Θ&|T_{I}(Θ₃)−T_{R}(θ₃)|<Θ|T_{I}(α₁)−T_{R}(α₁)|<A&|T_{I}(α₂)−T_{R}(α₂)|<A&|T_{I}(α₃)−T_{R}(α₃)|<A, (3)

where L, Λ, Θ and A are the thresholds, and the internal angles can be computed by:

λ₁=π−(α₂−α₃)

λ₂=π−(α₃−α₁)

λ₃=π−(α₁−α₂). (4)

If the geometric parameters do not satisfy any of the conditions, then we can discard those elements that are impossible mated and the information about those elements will not go to determine the triangle weighting value. However, once a pair of triangles meets all the conditions, then the direction of a triangle element-D can be defined as the average of the difference between input I and reference R angles:

$$D = \frac{\vert {T}_{I} ( {α}_{1} ) - {T}_{R} ( {α}_{1} ) \vert + \vert {T}_{I} ( {α}_{2} ) - {T}_{R} ( {α}_{2} ) \vert + \vert {T}_{I} ( {α}_{3} ) - {T}_{R} ( {α}_{3} ) \vert}{3} . \qquad ( 5 )$$

It's an average effect of the three angles that between each side of the triangle and the X-axis. In order to decide the tendency of the direction of these triangular elements, dividing the plane space into n equal sectors: D₁, D₂, . . . Dₙ. By statistic point of view, if there is a rotating effect between the input test and reference triangular elements, this effect will apparent in a sector among one of the D₁, D₂, . . . Dₙ. In other words, we use the histogram of the directions to decide the tendency, somewhat like windrose diagram which often use in meteorology. For each direction Dₘ(m=1,2, . . . n), the weighting of all the possible matched pairs of triangle elements is:

$$W ( {D}_{m} ) = {\sum }_{i = 1}^{{N}_{p}} {\sum }_{j = 1}^{{N}_{p}} {\sum }_{k = 1}^{{N}_{p}} {\sum }_{r = 1}^{{N}_{q}} {\sum }_{g = 1}^{{N}_{q}} {\sum }_{t = 1}^{{N}_{q}} [ L - ( \vert {T}_{I} ( {l}_{ij} ) - {T}_{R} ( {l}_{rs} ) \vert ) + L - ( \vert {T}_{I} ( {l}_{ik} ) - {T}_{R} ( {l}_{rt} ) \vert ) + L - ( \vert {T}_{I} ( {l}_{jk} ) - {T}_{R} ( {l}_{st} ) \vert ) ] . \qquad ( 6 )$$

Where T_{I} and T_{R} are the the input test matrix and the reference matrix respectively, and L is the threshold of length in (3).

Continuously, In the step 105, Converting the coordinate; to convert a set of the points to the new coordinate needs to determine four parameters, of which the coordinates of the four most matched pairs in the highest weighting value direction, i.e.

∀m, W(Dₕ)=max{W(Dₘ)} (7)

(m=1, 2, . . . n), where the angle depending on the weighting value W(D) is introduced in the step 104. Using the four most matched pairs to determine the rotation and translation parameters of coordinate, in which convert a set of the points to the new coordinate:

$$[ \begin{matrix}NewX \\ NewY\end{matrix} ] = [ \begin{matrix}{t}_{1} \\ {t}_{2}\end{matrix} ] + [ \begin{matrix}{r}_{1} & - {r}_{2} \\ {r}_{2} & {r}_{2}\end{matrix} ] [ \begin{matrix}X \\ Y\end{matrix} ] . \qquad ( 8 )$$

where t₁ and t₂ are the translation parameters, r₁ and r₂ are the rotation parameters.

After finding these four parameters, the coordinate can be converted into the new one. After coordinate converting, one can find the average distance (S) between the points of new set (X_{New}, Y_{New}) and the corresponding points of the reference set (X_{ref}, Y_{ref}):

$$S = \frac{{S}_{I}}{{N}_{m}} = \frac{{\sum }_{β = 1}^{{N}_{m}} [ {( {x}_{new β} - {x}_{ref β} )}^{2} + {( {y}_{new β} - {y}_{ref β} )}^{2} ]}{{N}_{m}} . \qquad ( 9 )$$

where Nₘ is number of the matched points. Finally, In the step 106, Calculating the similarity; the similarity is determined by the combinations of the weighting value such as (W) and the number of matching points such as (Nₘ), the average of the distance between each correctional new points of one set and corresponding points of another set. The similarity such as (Sim) is simply a algebra function of weighting value (W), Inverse of the average distance (1/S), number of matching pairs (Nₘ), (Nₚ)—the number of points in input set and (N_{q})—the number of points in reference set. Therefore, it is defined as:

$$Sim = \frac{{WN}_{m}^{2}}{{SN}_{p} {N}_{q}} , \qquad ( 10 )$$

which can be completed the triangle matching method of the invention.Referring to FIG. 2, which further illustrates the flow chart of the FIG. 1; the step 200 and step 201 are included into the Step 102 of the FIG. 1. The step 202 is included into the step 104 of the FIG. 1. And the steps from 203 to 207 are included into the step 106 of FIG. 1. Regarding the steps from 200 to steps 207, we had described these within the FIG. 1.

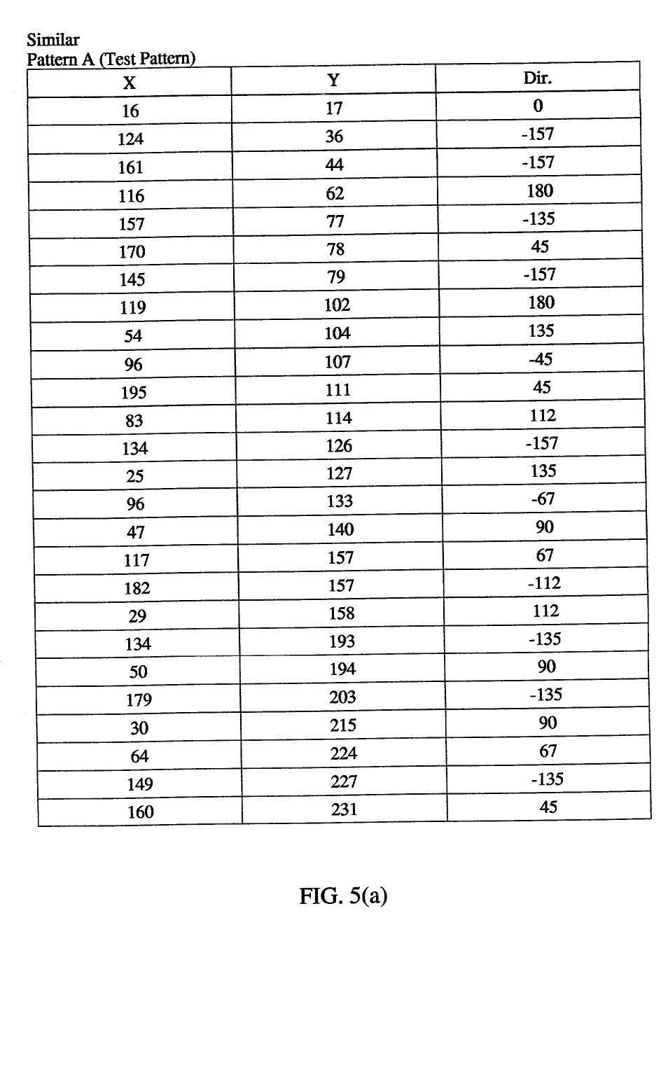

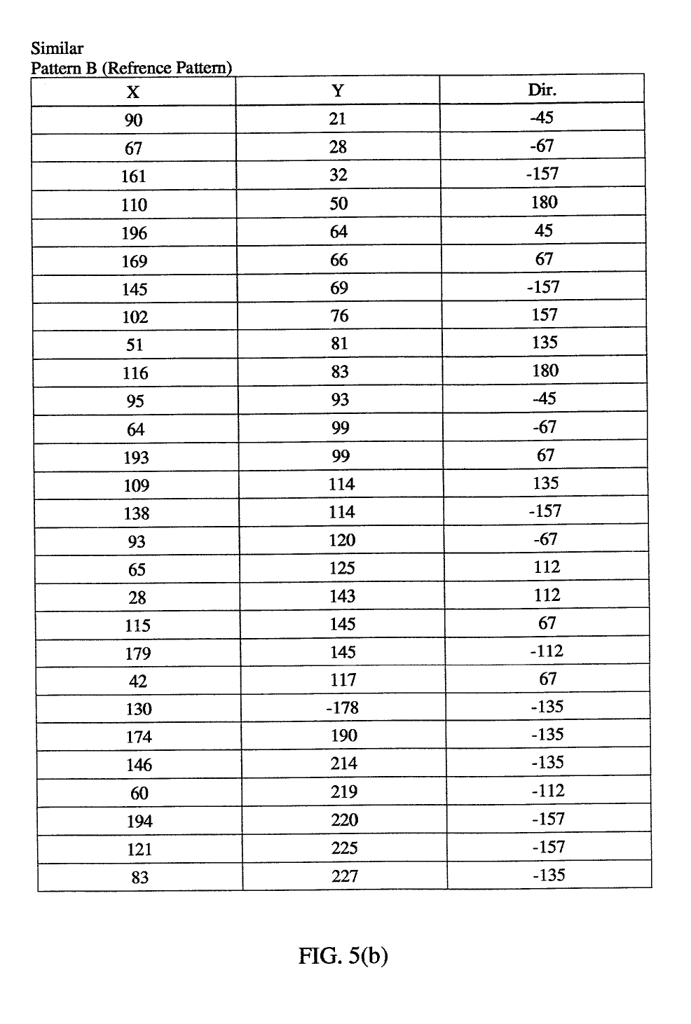

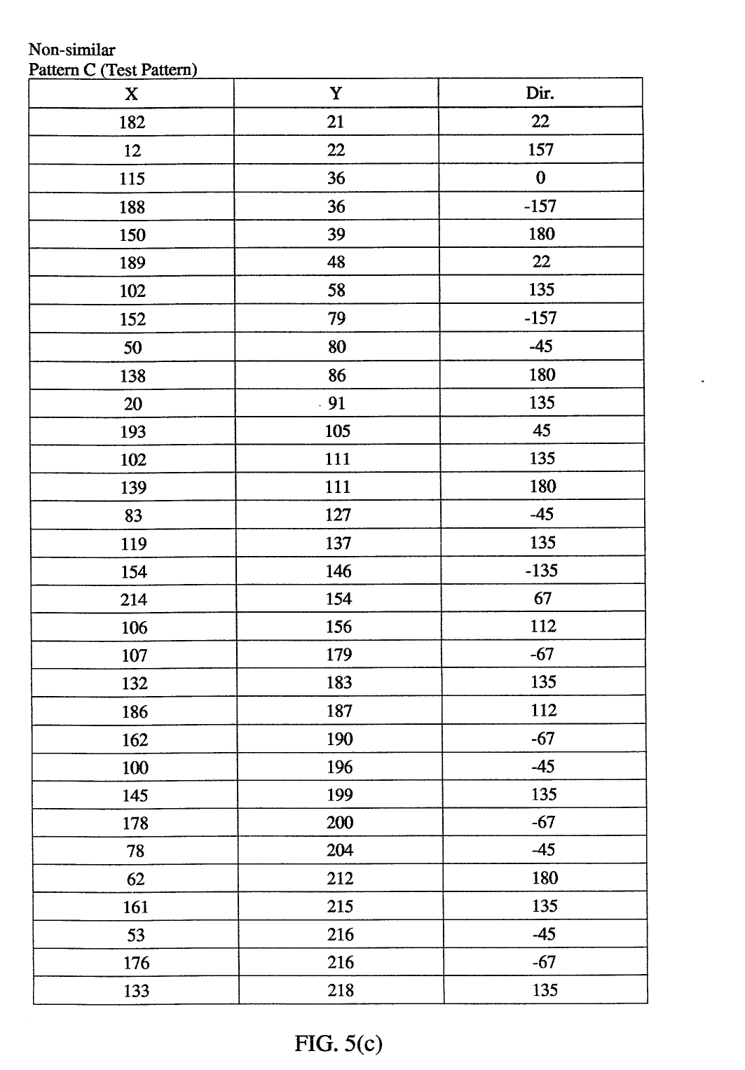

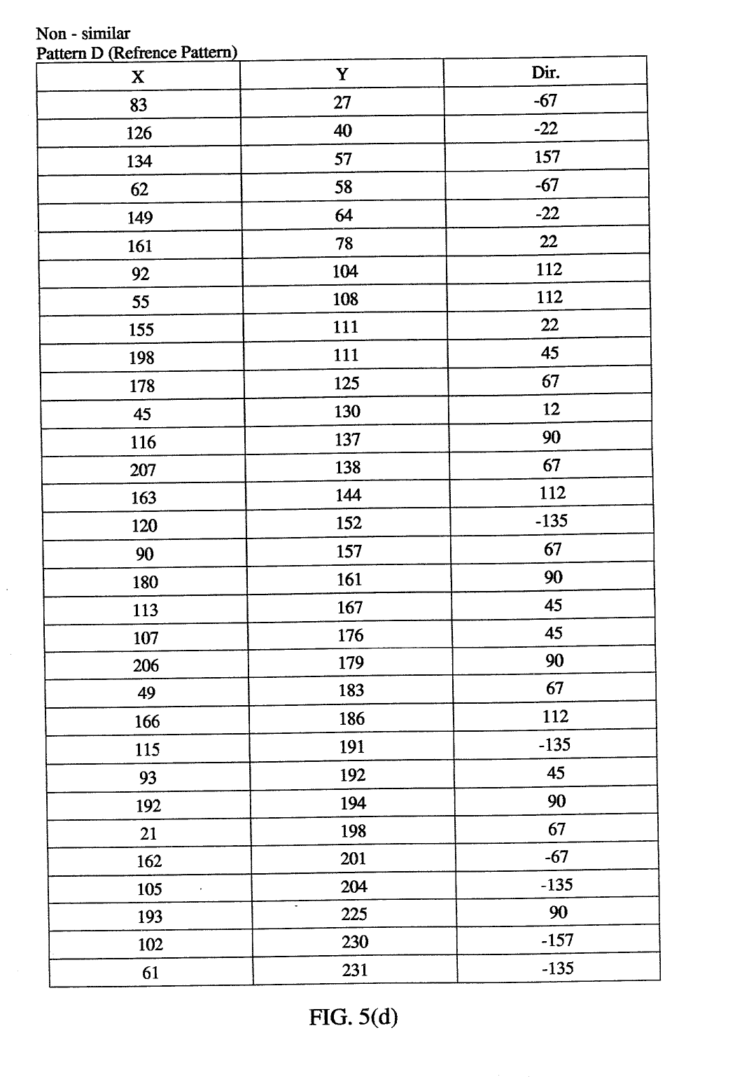

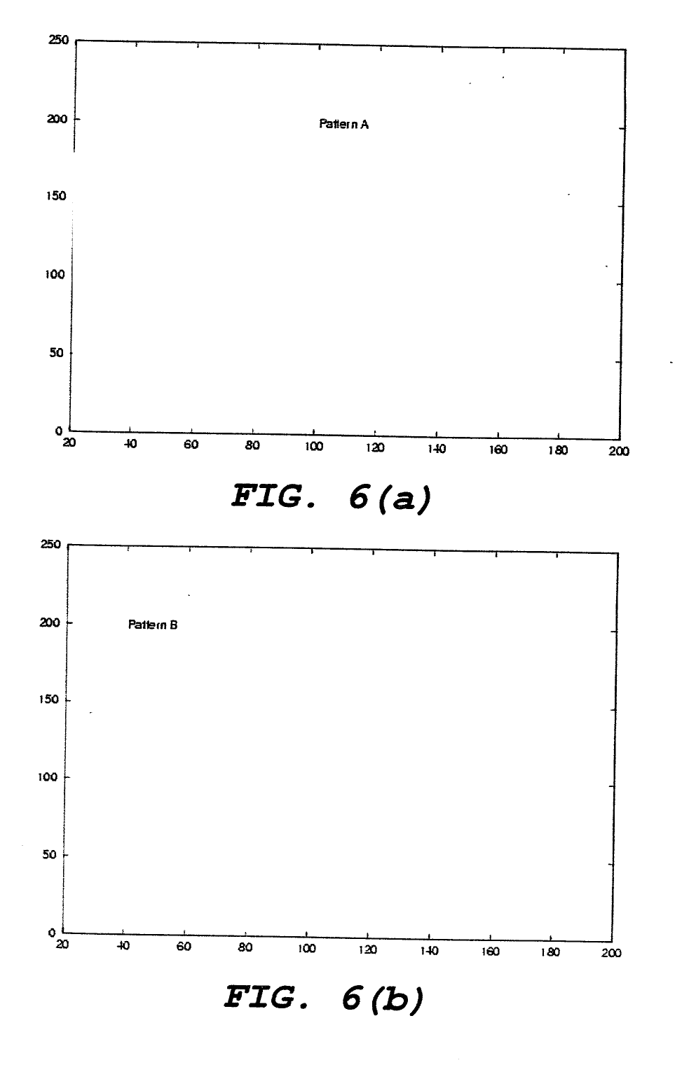

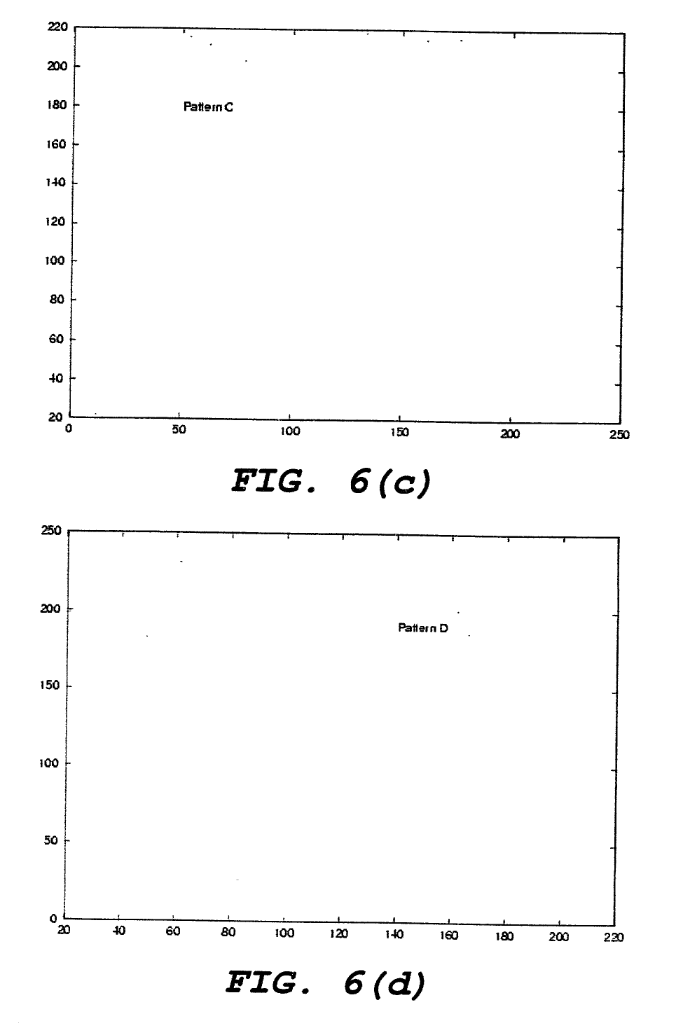

FIG. 5 (a), (b), (c) and (d) illustrate two set pairs of planar points patterns. Where one pair (Pattern A and Pattern B) are similar and another (Pattern C and Pattern D) are not. The coordinates and the feature directions of the points are listed in the tables. Among the patterns, Pattern A, the test pattern (FIG. 5(a)) is considered similar to Pattern B (FIG. 5(b)), the reference pattern, their positions are shown in FIGS. 6(a) and (b) corresponding. After triangle coarse matching, filtering out the impossible matching points, the first four matched pairs with highest weighting value are found to be:

(182, 157),(195, 111),(149, 227)(117, 157) (11)

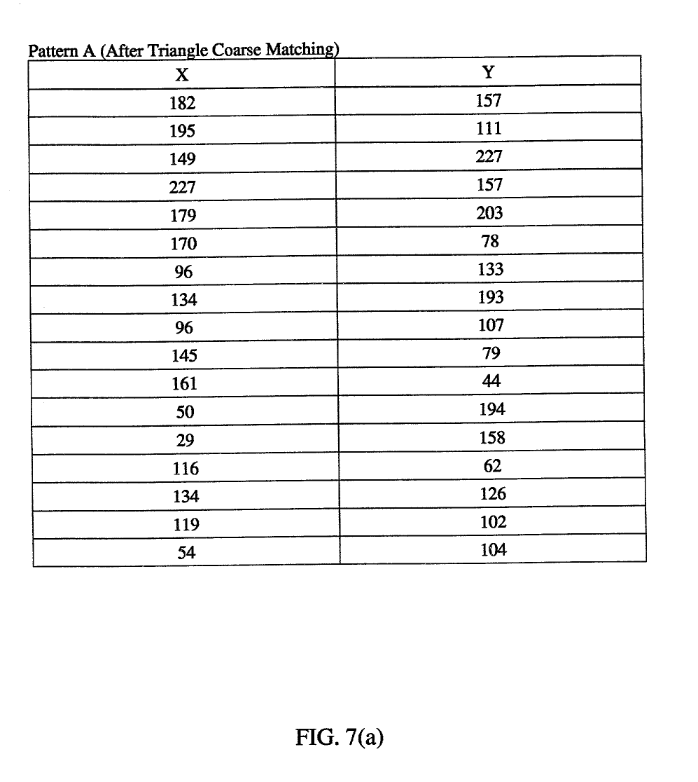

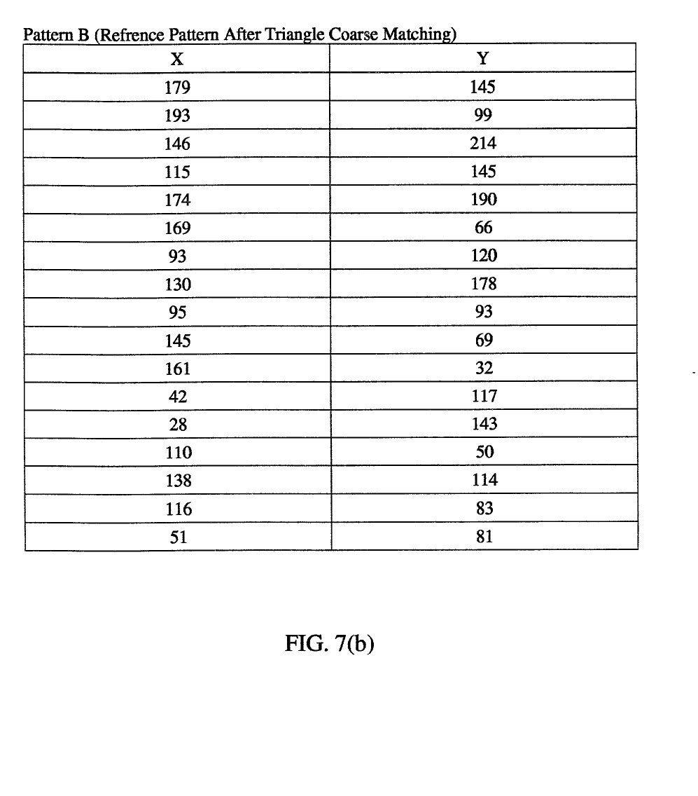

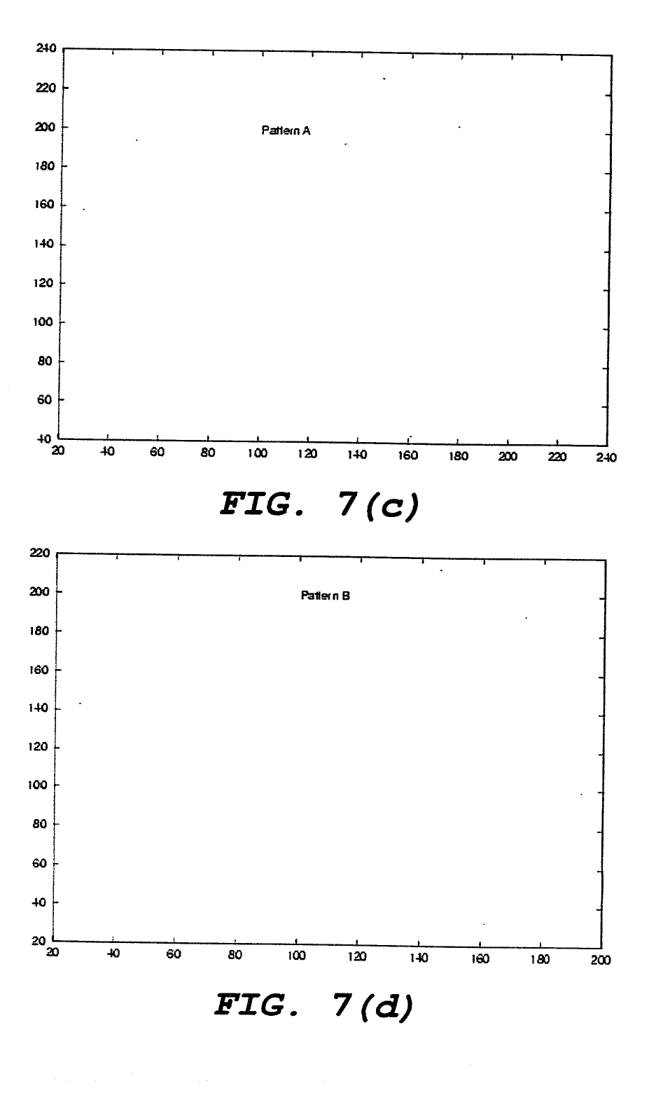

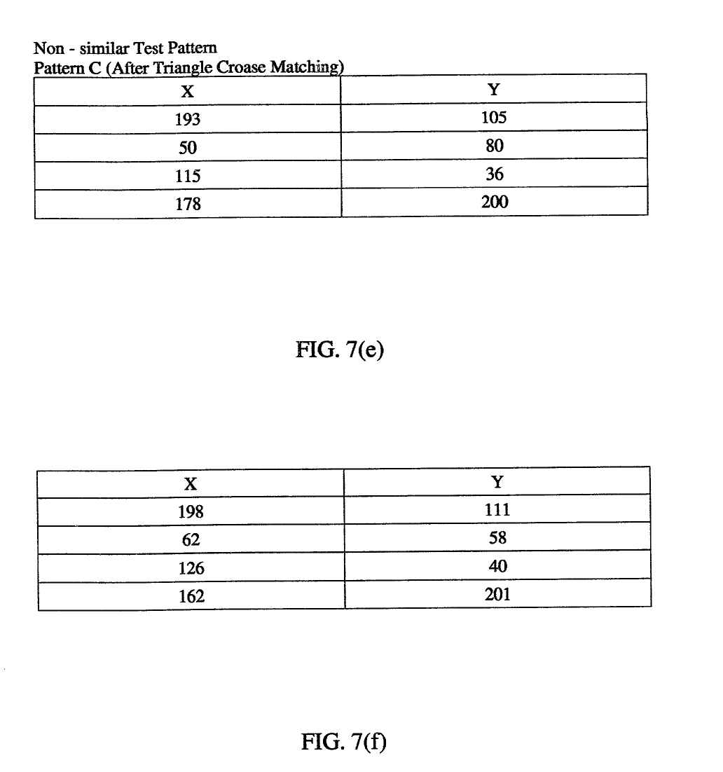

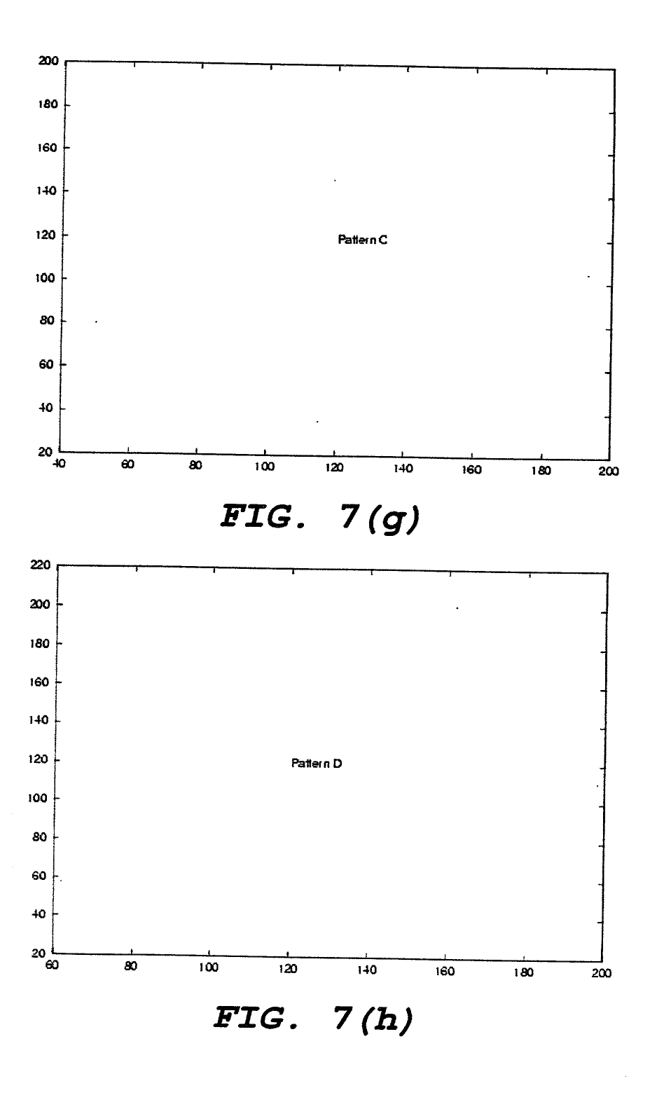

The remainder show in FIG. 7(a) (test pattern) and (b) (reference pattern).By (11) and using (8), the translation and rotation parameters are found to be:

t₁=0.223

t₂=−15.744

r₁=1.000

r₂=0.019. (12)

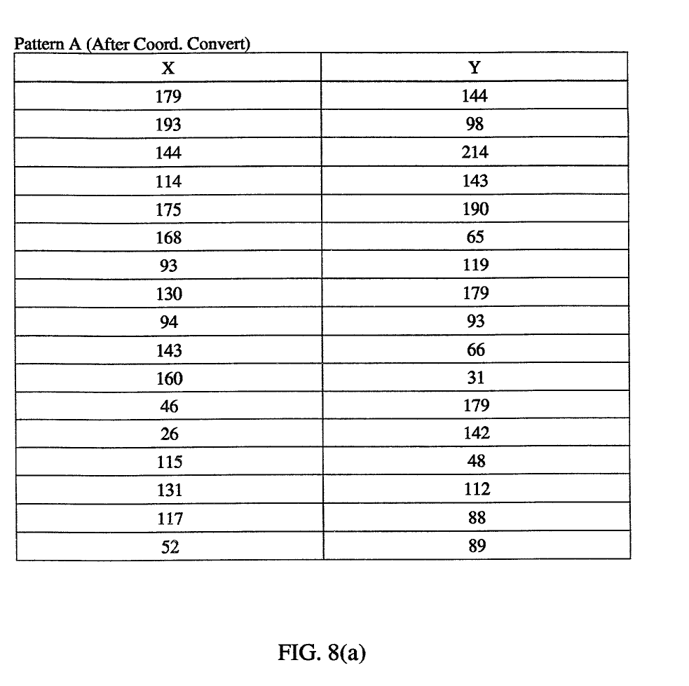

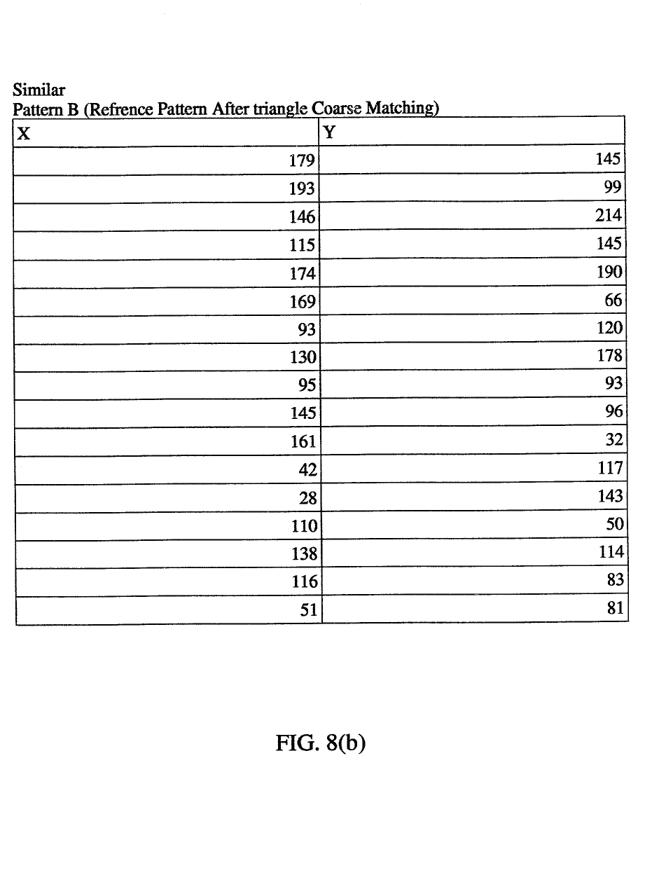

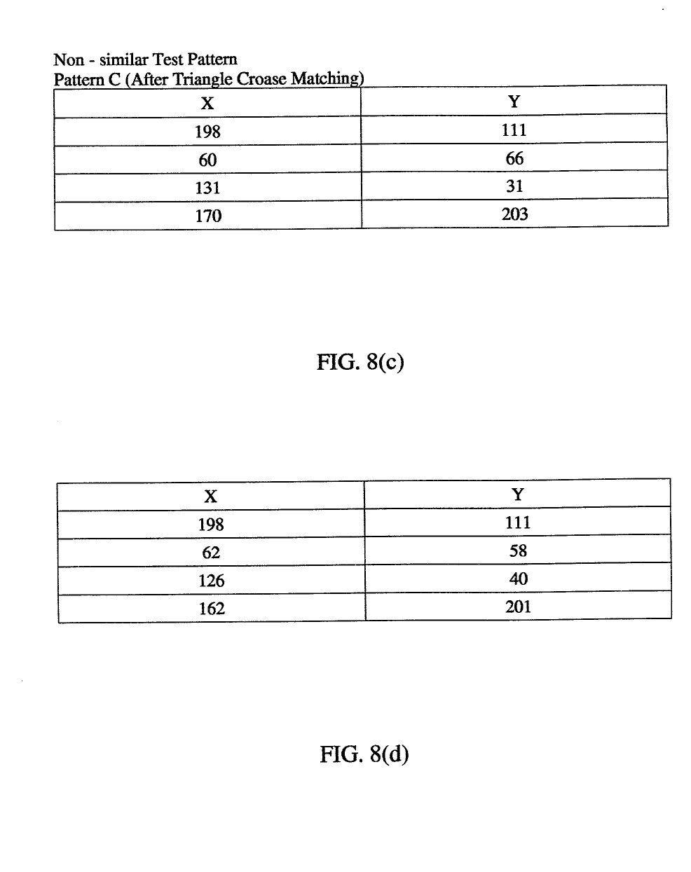

After translation and rotation conversion, the coordinate of the test pattern is shown in FIG. 8(a). The weighting value W is:

$$W = {\sum }_{i = 1}^{17} {w}_{i} = 23946 \qquad ( 13 )$$

In this case, where represents the individual weight of the matched points. According to (9), the average distance is:

$$\begin{matrix}{S}_{I} = {\sum }_{β = 1}^{17} [ {( {x}_{new β} - {x}_{ref β} )}^{2} + {( {x}_{new β} - {x}_{ref β} )}^{2} ] = 221.633 and & ( 14 ) \\ S = \frac{{S}_{I}}{17} = 13.03 & ( 15 )\end{matrix}$$

By (13), (14) and (15), the similarity is:

$$Sim = \frac{23946 ( \frac{17}{26} ) ( \frac{17}{28} )}{13.03} = 729.5 \qquad ( 16 )$$

It considers to be a high similarity matching sets. Next, we show another non-similar case. The test pattern C (FIG. 5(c)) is considered NOT similar to the reference Pattern D (FIG. 5(d)), the reference pattern, their positions are shown in FIGS. 6(c) and (d) corresponding. After triangle coarse matching, filtering out the impossible matching points, the first four matched pairs with highest weighting value are found to be:

(193, 105),(50, 80),(115, 36),(178, 200) (17)

The remainder shows in FIG. 7(c) (test pattern) and (d) (reference pattern). By (17) and using (8), the translation and rotation parameters are found to be:

t₁=22.517

t₂=−20.239

r₁=0.990

r₂=0.143. (18)

After translation and rotation conversion, the coordinate of the test pattern is shown in FIG. 8(b). The weighting value becomes:

$$W = {\sum }_{i = 1}^{4} {w}_{i} = 1745 \qquad ( 19 )$$

In this case, where represents the individual weight of the matched points. According to (9), the average distance is:

$$\begin{matrix}{S}_{I} = {\sum }_{β = 1}^{4} [ {( {x}_{new β} - {x}_{ref β} )}^{2} + {( {x}_{new β} - {x}_{ref β} )}^{2} ] = 230.088 and & ( 20 ) \\ S = \frac{{S}_{I}}{4} = 57.52 & ( 21 )\end{matrix}$$

By (19), (20)and (21), similarity is:

$$Sim = \frac{1745 ( \frac{4}{32} ) ( \frac{4}{32} )}{57.52} = 0.47 . \qquad ( 22 )$$

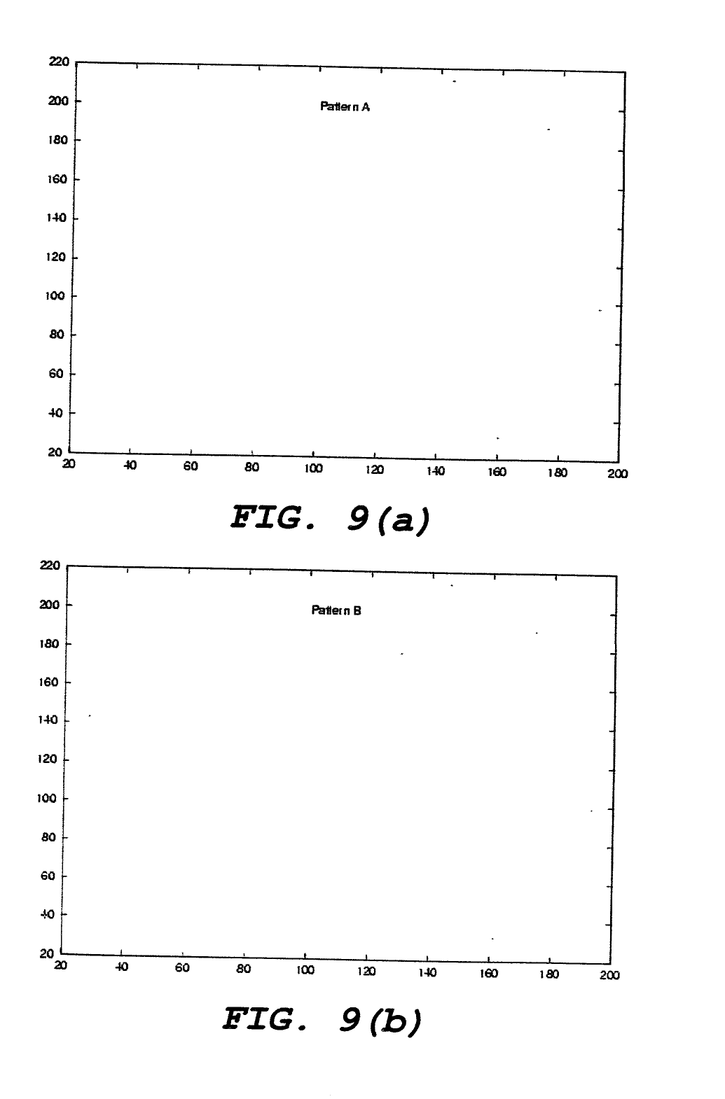

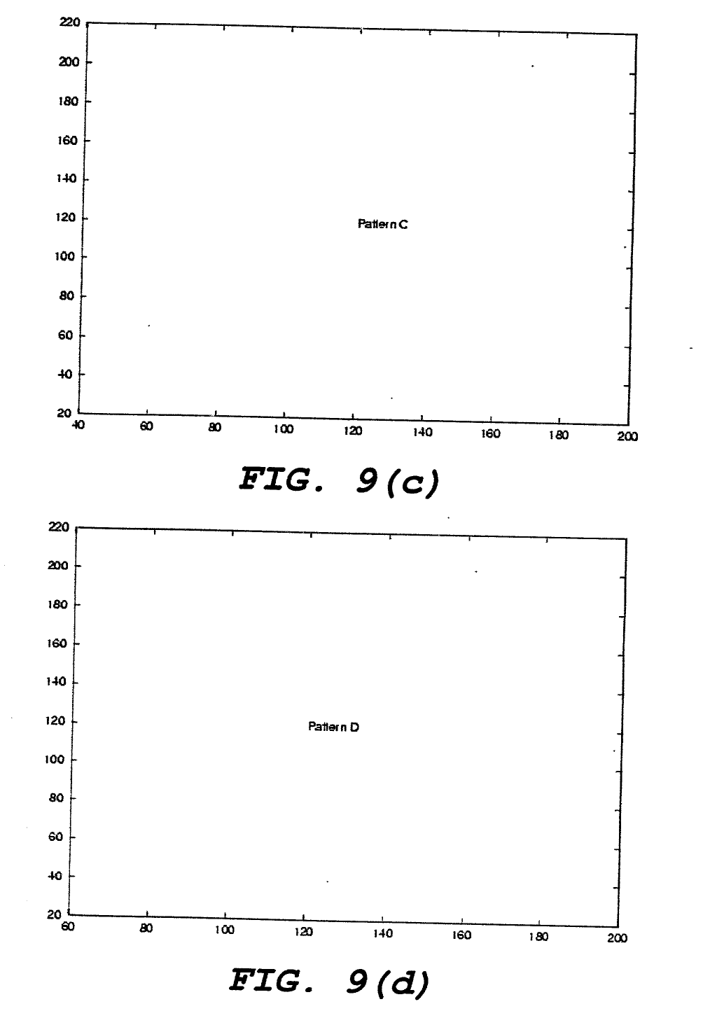

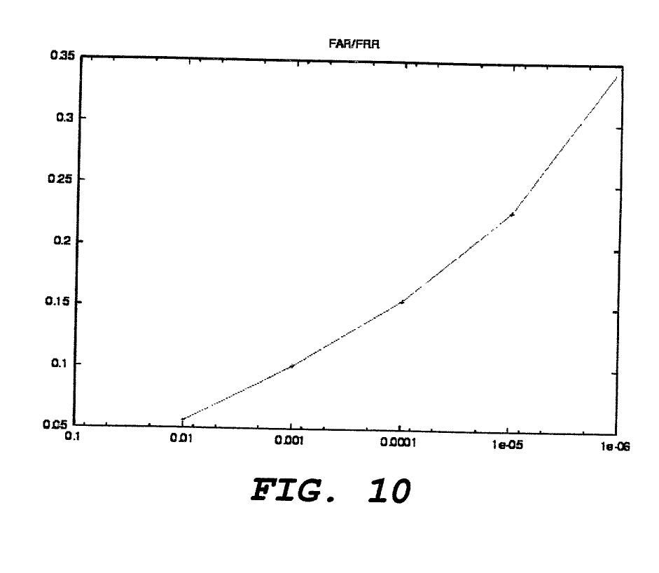

From (22), the value of similarity indeed, is low. FIGS. 8 illustrates how the results alter after converting coordinate process. FIG.8 (a) and (b) represent the coordinates of the similar test and reference patterns while FIG.8(c) and (d) show the non-similar pair; FIGS.9 illustrates the positions of the similar test pattern, as shown in FIG. 9 (a), and the non-similar one, as shown in FIG. 9 (b), after the translation and rotation conversion about the two pair of planar points patterns; and In order to prove that the effects of this invention satisfies the high precision as we need, there are 2520 fingerprints in the database, 126 fingers, each with 20 same fingerprints. The number of similar matching is: 126*(20)*(20−1)=47880, every pattern obtained from a finger is matched with patterns from other fingers. The number of non-similar matching is: ((126−1)*20)*2520=6300000, the results of the matching of patterns of 2520 finger prints obtained from 126 fingers is shown in FIG. 10. The FRR of this invention is quit well. The above description only the framework of this invention. Those technology will be able to have further improvement and modification with the spirit and framework of this invention, but all such improvement or modification should be under the scope of this present invention.

What is claimed is:

1. A triangle automatic matching method provides a unique and precise matching method that can be used to judge the similarity of two sets of planar points, comprising: Generating a plurality of triangular elements and matching-related flag matrices upon a coordinate; Determining a triangle weighting value combined with triangle coarse matching depending on said triangular elements and said flag matrices; Converting said coordinate depending on said triangle weighting value; and Calculate said similarity depending on said triangle weighting value.

2. The method as in claim 1, wherein said first step further includes generating a list of all the possible side of a triangle based on the vertices of each triangle and 12 geometrical parameters stored in two matrices.

3. The method as in claim 1, wherein said first step further includes generating a matching related flag matrix under a plurality conditions, and setting said flag matrix.

4. The method as in claim 1, wherein said triangle weighting value can to find the tendency of direction about the triangular elements and also to determine the shift and rotation parameters.

5. The method as in claim 1, wherein before said third step, flag matrix must first be verified, then going on with triangle coarse matching.

6. The method as in claim 1, wherein said triangle coarse matching is to filter out the impossible mated points of said triangle elements according to the geometrical parameter thereof in a input set and a reference set, then setting a plurality of predetermined conditions to determine whether said triangle element from said input set and said triangle element from said reference set are definitely mated or not. If said geometric parameters do not satisfy said conditions, then discarding said elements, if so, said triangle element can be defined as an average of the difference between said inputs set and said reference sets angle.

7. The method as in claim 6, wherein said fourth step further comprises converting said points to the new coordinate after determining the four parameters of said geometric parameters.

8. The method as in claim 1, wherein said similarity is determined by the combination of said weighting value and said points.

9. The method as in claim 1, wherein said similarity is simply an algebra function.
